(19) United States
(12) Patent Application Publication
(10) Pub. No.: US 2005/0182713 A1
(43) Pub. Date: Aug. 18, 2005

(54) Methods and systems for the auto reconsideration of credit card applications

(76) Inventor: Giancarlo Marchesi, Huntington, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/955,504

(22) Filed: Sep. 30, 2004

Related U.S. Application Data
(60) Provisional application No. 60/507,534, filed on Oct. 1, 2003.

(51) Int. Cl. G06F 17/60

(52) U.S. Cl. 705/39

(57) ABSTRACT

This invention relates to methods and systems for determining a credit card applicant's creditworthiness wherein the applicant is allowed a period following the initial review and rejection of his or her credit card application in which the applicant may cure the credit deficiencies and receive automatic reconsideration of his or her improved application. In the event that upon reconsideration the application is deemed approvable, the process will automatically approve the application and provide notice to the applicant accordingly.

### 1 CROSS-REFERENCE TO RELATED APPLICATION

This application claims the benefit of U.S. Provisional Application No. 60/507,534, filed Oct. 1, 2003 by Giancarlo Marchesi and entitled “Auto Reconsideration”, the entire disclosure of which is hereby incorporated herein by reference.

### 2 FIELD OF THE INVENTION

This invention relates to methods and systems for determining an individual's creditworthiness wherein an applicant for a credit card is given a period following the initial review and rejection of his or her credit card application in which the applicant may cure the credit deficiencies and receive automatic reconsideration of the initially rejected application.

### 3 BACKGROUND OF THE INVENTION

Most credit cards are open lines of credit that a card holder can use to make purchases. Typically, credit cards and other types of payment instruments are issued and underwritten by financial institutions. In order to obtain a credit card, an individual must apply for the card by completing and submitting a credit card application to the card issuer. Each new application undergoes a review and analysis by the prospective issuer to determine if the applicant is “credit-worthy.” Determination of the credit-worthiness of the applicant forms the basis for the final approve/decline decision by the issuer.

Although credit issuers can use different criteria when considering a new credit card application, most issuers rely primarily on the following pieces of information: 1) the applicant's stated income, and 2) a credit-worthiness score derived from the applicant's credit information.

Generally speaking, such a credit score is calculated by using scoring models and mathematical tables that assign points for different pieces of information which best predict the risk that the applicant will not repay the loan. The credit score condenses a borrower's credit history into a single number. This credit score is widely used by lenders as a reliable means of credit evaluation.

The information considered in developing the score can include, but is not limited to, the length of the applicant's credit history, the number of reported credit card applications filed by the applicant, the applicant's reported delinquency history which can include information regarding the recentness and severity of the delinquencies, the applicant's bank card utilization, and/or the applicant's revolving balance acceleration. A detailed discussion of the credit card application evaluation process and credit-worthiness scoring is provided in U.S. Pat. No. 6,202,053 (issued to Christiansen, et al. on Mar. 13, 2001), which is hereby incorporated herein by reference.

Because a credit score is an amalgamation of the individual's credit history as it stands at the specific moment the information is captured, the process is commonly referred to as a “credit snapshot”. Currently, the automated credit card underwriting process relies only on this credit snapshot to form the basis of the approve/decline decision regarding the application. This binary evaluation process depends exclusively on the credit picture of the applicant representing the applicant's credit story at that instant in time. When the credit snapshot fails to satisfy the issuer's creditworthiness criteria, the application is summarily and finally rejected. However, the applicant's credit profile may be improved, the initial credit snapshot may contain an error, or a credit event may be improperly associated with the applicant (i.e., instances wherein the applicant shares the same name with another and the other's credit event wrongly appears on the applicant's credit report). Because the conventional credit application process does not consider these situations, many applicants are being denied that should be approved, thereby resulting in a loss of revenue to credit card issuers. Accordingly, there is a need in the art for a more thorough credit card application consideration process.

### 4 SUMMARY OF THE INVENTION

The problems discussed above are addressed and a technical solution achieved in the art by methods and systems for the consideration of credit card applications which includes reconsideration of initially declined applications. In particular, for a period of time following the initial rejection of the application, the application remains open for review by the credit issuer. During this time, the applicant is given the opportunity to correct or cure deficiencies in his or her credit background to improve the application. Improvement to the strength of the application made by the applicant is considered by the credit issuer. If upon reconsideration the cured application is deemed “credit-worthy,” the application is automatically approved.

According to an aspect of this invention, a credit card application is no longer judged solely upon a single credit snapshot. Instead, the embodiments of this invention allow for the credit card application to be reviewed over a period of time, allowing for the consideration of changes made by the applicant to his or her credit background.

One embodiment of the current invention provides a method for processing and considering credit card applications by capturing additional credit reports from one or more credit bureaus over a period of time following the initial evaluation of the application. If the issues which originally led to the denial of the application are “cured,” the adverse status may be changed and the application will be granted accordingly. Instead of just taking a single moment-in-time credit snapshot of the applicant's credit profile to make the final approve/decline decision, the application remains open for a period of time to allow periodic and ongoing review of the applicant's credit-worthiness. Advantageously, this reconsideration period provides those applicants whose credit profile did not initially satisfy credit-grant requirements the opportunity to remedy their credit background and have the improved application automatically reconsidered.

In another embodiment of the current invention, the applicant is given the option to participate in the reconsideration process. According to this embodiment, the applicant can elect to have his or her application reconsidered at a later time to determine if there has been sufficient improvement to satisfy the issuer's credit-worthiness criteria.

### 5 BRIEF DESCRIPTION OF THE FIGURES

The advantages, nature and various additional features of the invention will appear more fully upon consideration of the illustrative embodiments now to be described in detail in connection with the accompanying figures. In the figures:

FIG. 1 illustrates the steps involved in the automatic reconsideration process according to the invention;

FIG. 2 is a schematic depiction of an embodiment of the auto reconsideration system of the current invention; and

FIG. 3 illustrates an embodiment of the invention wherein the applicant elects to participate in the auto reconsideration process.

It is to be understood that these figures are for purposes of illustrating the concepts of the invention and are not to scale.

### 6 DETAILED DESCRIPTION OF THE INVENTION

The present invention relates to methods and systems for determining the credit-worthiness of credit card applications wherein the credit card applicant is given a period of time, or reconsideration period, in which the applicant can improve his or her credit status and receive automatic approval. According to the methods and systems of the invention, the credit issuer re-evaluates initially-declined applications one or more times during the reconsideration period to determine if the application has achieved credit-worthy status. Advantageously, applications are reconsidered based on the applicant's updated credit information thus capturing any improvement made by the applicant to his or her credit profile since the initial review.

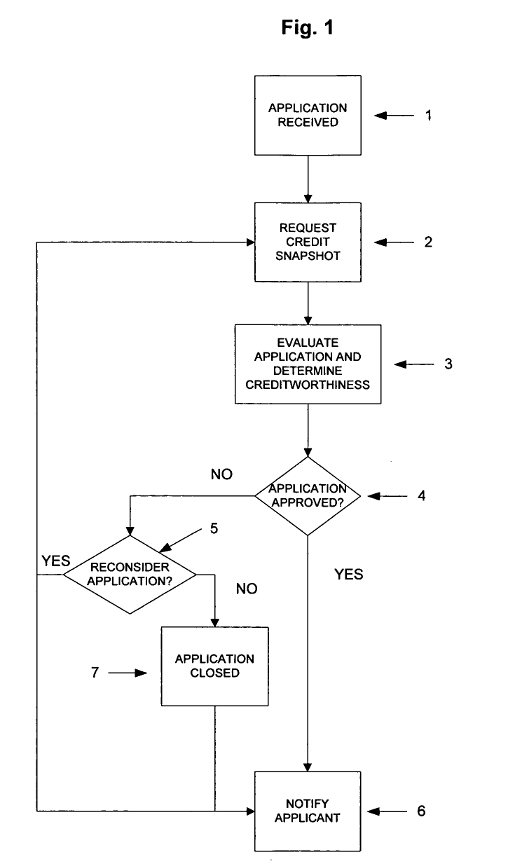

FIG. 1 provides a flowchart of the steps for processing a credit card application according to the current invention. According to one embodiment of the invention, the credit card applicant (“applicant”) completes his or her credit card application (“application”) and submits the application to a credit card issuer (“issuer”) 1. Generally, the application includes application data provided by the applicant as requested on the application. The application data includes, but is not limited to, the applicant's personal, financial and credit history data. For example, the application data can include, but is not limited to, the applicant's income or salary information.

Using the application data, the credit issuer requests and captures additional or updated credit information, referred to as the applicant's ‘credit snapshot’ 2. At 3, the credit snapshot and the application data are evaluated by the issuer using the approve/decline criteria established by the issuer. Based on this creditworthiness analysis, the issuer makes an approve/decline decision 4. If the application is approved, the applicant is notified accordingly 6.

If the application is declined, the issuer determines if the application should be reconsidered 5. This decision can be based on a number of factors established by the issuer. A more detailed discussion of exemplary methods to determine if the application should be reconsidered is presented below. After determining that the application is to be reconsidered, the process returns to step 2 and a new credit snapshot is taken to determine if the applicant's credit status has improved. As shown in FIG. 1, steps 2-6 of the process are repeated until either the application is approved or the application is no longer eligible for reconsideration and thus considered ‘closed’ 7. If upon reconsideration, the application satisfies the issuer's criteria for credit-worthiness, the application is automatically approved. Typically, either end event (approved application or closed application) is accompanied by the sending of a corresponding notification to the applicant 6.

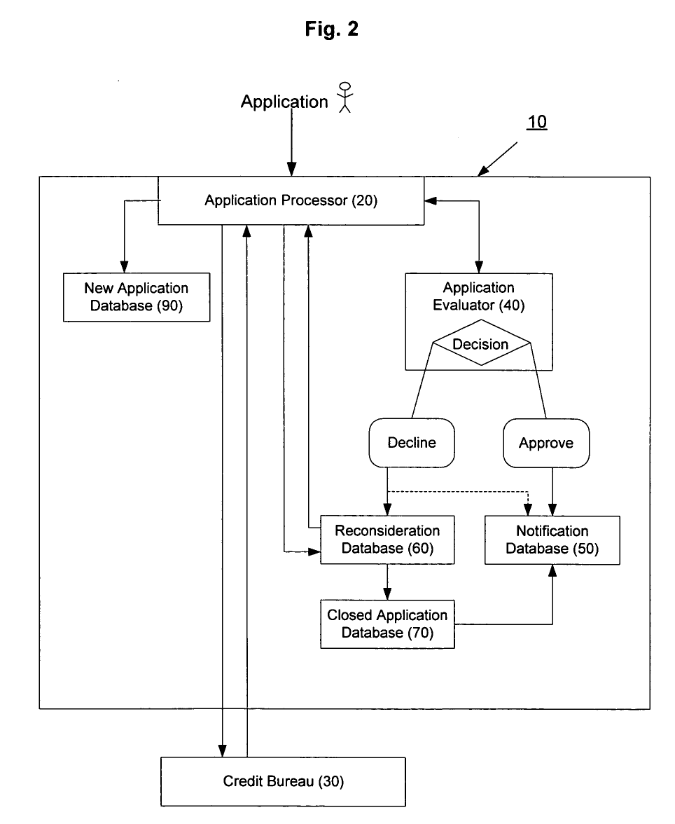

FIG. 2 provides a schematic depiction of the auto reconsideration method and automatic reconsideration system according to the current invention. It is to be understood that the schematic representation of the system provided in FIG. 2 is exemplary in nature and alternative arrangements are within the scope of the invention.

Referring to FIG. 2, applicant submits his or her application to the credit issuing entity for entry into automatic reconsideration system 10. Automatic reconsideration system 10 comprises application processor 20, application evaluator 40, notification database 50, reconsideration database 60, closed application database 70, new application database 90 and approved application database 80, stored on one or more computer-readable memories and arranged and communicatively connected as described in detail below. Although shown separately, one skilled in the art will appreciate that databases 50, 60, 70, 80, and 90 may be combined into a single or multiple databases. The term “computer-readable memory” is intended to include any computer-accessible data storage device, whether volatile or non-volatile, electronic, optical, or otherwise. Further, the term “communicatively connected” is intended to include any type of connection, whether wired or wireless, in which data may be communicated. The term “communicatively connected” is also intended to include a connection between devices within a single computer or between devices on separate computers. For example, all of the elements in system 10 may be located within a single computer or may be located within different computers that are connected via a network.

A new application enters automatic reconsideration system 10 and is provided to application processor 20. Generally, the application includes application data provided by the applicant for use in processing the application. The “application data” typically includes, but is not limited to, the applicant's name, street address, social security number, employment status, employer name, annual salary, financial data, credit history data and marital status. The application data requested by the credit issuer can vary depending on the criteria used by the credit issuer to evaluate the application.

Application processor 20 performs an initial review of the application to determine if the required application data has been provided by the applicant. The functions performed by application processor 20 are customizable depending upon the credit issuer's specific protocol for fielding and processing new credit applications. Such functions are known to one having ordinary skill in the art. It is contemplated that application processor 20 can be a computer that automatically performs these functions and/or a person or persons which manually carry out these functions.

Following the preliminary check of the application to ensure it is in good order, the application data is used to request the applicant's credit information from the one or more credit bureaus. The capturing of the applicant's credit profile is known as the credit snapshot. This credit information can include, but is not limited to, the length of the applicant's credit history, the number of reported credit applications filed by the applicant, the delinquency record of the applicant, the applicant's bank card utilization (the percentage of the ratio of balance to limit on revolving and national applications), revolving balance acceleration and/or the applicant's FICO score as determined by one or more of the three primary credit bureaus (Experian, Trans Union and Equifax).

As shown in FIG. 2, application processor 20 sends a request to one or more credit bureaus 30 and retrieves the credit snapshot. The one or more credit bureaus 30 respond to the query and provide the requested information to application processor 20 thereby bringing the application into condition for evaluation on the merits.

Optionally, either upon receipt of the application or after receiving the credit snapshot, the application can be sent by application processor 20 to the communicatively connected new application database 90 for storage. New application database 90 can be accessible to the credit issuer for various reasons including but not limited to marketing research, etc.

After compiling the application data and credit snapshot, the application is ready for consideration and provided by application processor 20 to a communicatively connected application evaluator 40. Application evaluator 40 considers the application based on the criteria set by the credit issuer to make a determination whether the application should be approved or declined. The specific criteria used by the credit issuer to assess the credit-worthiness of the applicant is customizable and may be defined by the given credit issuer. Optionally, the credit issuer develops a credit score for each applicant based on the applicant's credit information.

In a preferred embodiment, the criteria used by the credit issuer to determine an applicant's credit-worthiness can be a computer-executable algorithm that, for example, approves all applications associated with a credit score greater than a minimum approvable score determined by the credit issuer. For example, the evaluation process can be designed such that applications having a credit score of greater than or equal to 700 are deemed approvable. According to this embodiment, application evaluator 40 comprises a computer capable of executing the credit-worthiness evaluation algorithmic steps. One skilled in the art will appreciate that a single computer could be used to perform the functions of application processor 20 and application evaluator 40.

If, following the analysis by application evaluator 40, the application satisfies the credit-worthiness criteria, the application is ‘approved’ and sent by application evaluator 40 to the communicatively connected notification database 50. Applications stored in notification database 50 are accessible by the credit issuer for the subsequent generation of a communication notifying the applicant of the status of his or her application. This notice can be provided to the applicant via any known method of communication, including but not limited to, a letter, an email, or a telephone call.

If the application is declined or rejected based on the review by application evaluator 40, the application is provided by application evaluator 40 to the communicatively connected notification database 50. Notification database 50 stores the application for providing future notice to the applicant of the rejection. Typically, the communication of this adverse decision provides a reason or reasons for the decision to decline the application. Preferably, the communication regarding the declined application informs the applicant of the automatic reconsideration process and provides an explanation of how the process works.

In addition, application evaluator 40 sends all or a selected portion of the initially rejected applications to the communicatively connected reconsideration database 60. According to one embodiment, automatic reconsideration system 10 can be designed and/or programmed to automatically reconsider all initially-rejected applications. Alternatively, the system can be programmed or designed to select a portion of the declined applications for reconsideration. This selective reconsideration can be based on a variety of factors established by the credit issuer. The system can be designed to flag certain applications based on how the application compared to the credit-worthiness criteria. For example, a credit issuer may require as a part of their credit-worthiness criteria that the applicant have a minimum credit score of YYY. In this example, application evaluator 40 can be programmed such that any application having a credit score within a range of XXX to YYY-1, while not initially approvable, is flagged as an initially declined application which warrants reconsideration. According to this example, scores XXX and YYY can be 690 and 700, respectively, for credit issuers who seek applicants having low-risk credit profiles. Automatic reconsideration system 10 can be designed and/or programmed to automatically send applications falling within this tolerance range for storage in reconsideration database 60. The applications are maintained in reconsideration database 60 until they are reconsidered.

According to one embodiment, reconsideration database 60 provides ‘tags’ to applications which are received from application evaluator 40. These tags are application-specific information for use in setting the application's automatic reconsideration period (described in detail below). For example, reconsideration database 60 can tag an application with the date of initial review by application evaluator 40 as a marker of the beginning of the reconsideration period. In addition, reconsideration database 60 can determine the one or more optionally periodic intervals within the reconsideration period at which the application will be reconsidered. Thus, upon query from application processor 20, reconsideration database 60 can search its contents for applications due for reconsideration based on the applications' review interval information.

Optionally, reconsideration database 60 can tag the application with additional information related to the reconsideration process, including but not limited to, the date of initial review of the application, the one or more credit snapshots taken with respect to the application, and/or the date and result of any prior reconsideration reviews of the application.

According to an aspect of the invention, the issuer grants the applicant a period of time (the “automatic reconsideration period”) during which the application remains open for automatic reconsideration by the issuer. The automatic reconsideration period can begin at any time chosen by the issuer. For example, the automatic reconsideration period can begin to run from: the date of receipt of the application; the date of the initial credit snapshot; the date of the initial rejection; the date of transmission of the notice of initial rejection; the date of receipt of the notice of initial rejection; the date of transmission by the applicant of his or her election to participate in the program (the election process according to the invention is discussed in detail below); the date of the receipt by the issuer of the applicant's election to participate in the program, or an arbitrary start date. Preferably, the automatic reconsideration period begins to run from the date of the initial decline decision as established by the issuer.

The length of the automatic reconsideration period, or grace window, is determined by the issuer and can be any length of time. Preferably, the length of the reconsideration period is any reasonable amount of time which provides the applicant an adequate opportunity to correct the credit deficiencies while not overburdening the credit issuer's application management resources. More preferably, the reconsideration period is at least six months. Even more preferably, the reconsideration period time is at least three months. Most preferably, the reconsideration period is at least one month.

In general, at periodic intervals during the automatic reconsideration period, the issuer reconsiders the declined application maintained in the reconsideration database by obtaining and reviewing a new credit snapshot. Based on this new credit snapshot the issuer determines if there has been a change to the applicant's creditworthiness. If not, the application remains open until the next periodic interval for reconsideration. If adequate curing of the application occurs during the automatic reconsideration period, the issuer automatically approves the application and provides notice to the applicant.

Referring to FIG. 2, on a periodic basis determined by the credit issuer (i.e., hourly, daily, weekly, monthly), application processor 20 queries the communicatively connected reconsideration database 60 to retrieve applications stored therein. Reconsideration database 60 searches its contents to determine which applications are in a condition for reconsideration and provides those applications to application processor 20.

At this stage in the process, the steps provided above are repeated for each application. First, application processor 20 queries one or more credit bureaus 30 to compile a new credit snapshot. Based on this new credit snapshot, application evaluator 40 reconsiders the application to form a new approve/decline decision.

Application evaluator 40 can be programmed to consider any number of factors or events which can improve an initially-declined application during the reconsideration period. One exemplary way to increase an application's credit-worthiness is by reducing or eliminating debt. One way to reduce debt is by canceling an existing credit card or paying down outstanding debt using personal savings or wealth. In addition, paying off accounts in a delinquent status results in an improvement to the applicant's delinquency record. An applicant can also reduce his or her debt associated with real property by refinancing an existing mortgage or trading in his or her existing residence for a less expensive one. Finally, an applicant can reduce or eliminate debt by terminating or altering existing debt agreements such as leases or automobile finance agreements.

Improvement to an application during the reconsideration period can also result from an increase in applicant's income. For example, the applicant may elect to include a spouse's income from an existing or new job to augment the stated income figure provided by the applicant and used in evaluating the application.

Yet another exemplary event which can cure a credit deficiency is the correction of any errors present in the applicant's credit profile. For example, the applicant can amend out-of-date or incorrect credit information relied on by the credit issuer in making the approve/decline decision. In addition, the applicant may coordinate with one or more credit bureaus to resolve an identity theft situation or other problems occurring due to a mistaken identity.

One of ordinary skill in the art will appreciate that the above examples are illustrative in nature and that there are a number of additional factors and events which may be considered by application evaluator 40 during the reconsideration period.

If upon reconsideration the application is in condition for approval, it is sent to notification database 50 for generation of the appropriate notice to the applicant. According to one embodiment of the invention, applications approved during the reconsideration period following curing or improvement of credit deficiencies are granted a credit card having certain limitations, including but not limited to a reduced line of credit and/or a limited trial period. Preferably, the reduced line of credit is any amount less than the typical credit allotted to a similarly situated applicant whose application was granted based on the initial evaluation. Preferably, the trial period is some period of time less than the typical period of time given to a similarly situated applicant whose application was granted based on the initial evaluation. Granting a limited form of credit to reconsidered applications contemplates that such cases present an increased credit risk to the credit issuer. Advantageously, credit issuers can apply these limitations to protect themselves against instances where the applicant's credit-worthiness fluctuates and drops below the acceptable level following the automatic approval.

If upon reconsideration the application is again declined, it is sent to reconsideration database 60 for possible future reconsideration. The reconsideration process described above continues until either the application is approved or the reconsideration period expires.

If at the end of the automatic reconsideration period the application is still not considered credit-worthy, the application is purged from reconsideration database 60 and sent to communicatively connected closed application database 70. Optionally, closed application database 70 provides closed applications to communicatively connected notification database 50 for provision of notice to the applicant regarding the application's closed status. The applicant can be notified via any suitable form of communication. Preferably, this communication includes instructions regarding the credit issuer's re-application process and can optionally include a new application.

According to one embodiment of the current invention, an additional review of applications in closed application database 70 is performed to ensure that no further reconsideration is appropriate.

According to another embodiment of the invention, the applicant can elect whether or not to participate in the automatic reconsideration process described in detail above. As such, an applicant interested in taking steps to improve his or her credit report can indicate this interest to the issuer by electing to have his or her application reconsidered. This election can be of either the opt-out or opt-in variety. By allowing the applicant to make an election, the issuer can avoid automatically reconsidering applications wherein the applicant does not wish to take steps to improve his or her credit history. Preferably, an applicant manifests his or her election by responding to the notice informing the applicant of the initial rejection of the application.

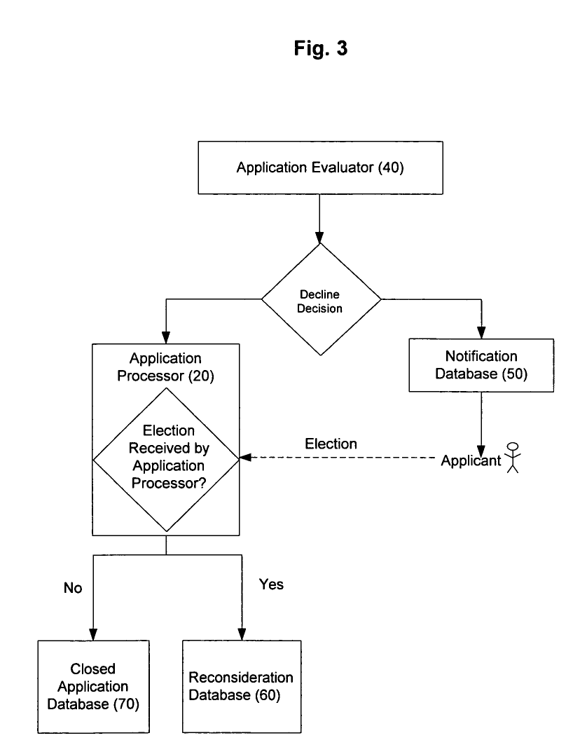

FIG. 3 provides a schematic depiction of the applicant-elected reconsideration process according to the second embodiment of the invention. The initial processing steps and initial evaluation steps are described in detail above. According to this embodiment, applicants whose rejected applications are in notification database 50 are provided with notice of the initial rejection of the application which includes instructions regarding the automatic reconsideration process and informs the applicant that he or she may elect to participate in the reconsideration program. For example, a notification letter can prompt the applicant to make an election by checking an appropriate box and sending the correspondence back to the issuer. It is contemplated that the election can be made and communicated by the applicant according to any method known in the art, such as by email or by a web page.

Following the initial decision to decline the application, application evaluator 40 provides the communicatively connected application processor 20 the application to store awaiting the applicant's election. Upon receipt of the applicant's election by the application processor 20, the application is sent by application processor 20 to reconsideration database 60. In the event no election is made by the applicant within a fixed period of time determined by the credit issuer, the initial decision is deemed a final adjudication of the application and application processor 20 sends the application to closed application database 70.

Although the present invention has been described in considerable detail with reference to certain preferred embodiments and versions, other versions and embodiments are possible. Therefore, the scope of the appended claims are not limited to the description of the versions and embodiments expressly disclosed herein. The references and disclosure provided in the ‘Background of the Invention’ section are not admitted to be prior art with respect to the disclosure provided in the current application.

1. A method for considering a credit card application, the method comprising:
receiving the application from an applicant;
compiling credit information related to the applicant;
evaluating the application based at least upon the credit information to determine whether to approve or reject the application; and
reconsidering a rejected application during a reconsideration period wherein the reconsidering further comprises requesting updated credit information and determining whether to approve or reject the application based at least upon the updated credit information.

2. The method of claim 1 further comprising storing information pertaining to the application in a computer-readable memory.

3. The method of claim 1 wherein the evaluating is performed by a computer.

4. The method of claim 1 wherein the reconsidering is performed by a computer.

5. The method of claim 1 wherein the credit information comprises at least one FICO score.

6. The method of claim 1 wherein the reconsideration period is at least one month.

7. The method of claim 1 wherein the reconsideration period is at least three months.

8. The method of claim 1 wherein the reconsideration period is at least six months.

9. The method of claim 1 wherein the reconsidering step is performed at least once during the reconsideration period.

10. The method of claim 1 wherein the reconsidering step is performed at a periodic interval within the reconsideration period.

11. The method of claim 1 further comprising notifying the applicant of the reconsidering step.

12. The method of claim 1 further comprising allowing the applicant to elect whether or not to participate in the reconsidering step.

13. The method of claim 1 wherein applications approved during the reconsideration period are granted a reduced line of credit.

14. The method of claim 1 wherein applications approved during the reconsideration period are granted for a trial period.

15. A computer-implemented method of considering credit card applications, the method comprising:
receiving the application from an applicant;
compiling credit information related to the applicant;
evaluating the application based at least upon the credit information to determine whether to approve or reject the application; and
reconsidering the rejected application during a reconsideration period wherein the reconsidering comprises receiving updated credit information and determining whether to approve or reject the application based at least upon the updated credit information.

16. The method of claim 15 further comprising storing information pertaining to the application in a computer-readable memory.

17. The method of claim 15 wherein the credit information comprises at least one FICO score.

18. The method of claim 15 wherein the reconsideration period is at least one month.

19. The method of claim 15 wherein the reconsideration period of time is at least three months.

20. The method of claim 15 wherein the reconsideration period of time is at least six months.

21. The method of claim 15 wherein the reconsidering is performed at least once during the reconsideration period.

22. The method of claim 15 wherein the reconsidering is performed at a periodic interval within the reconsideration period.

23. The method of claim 15 further comprising notifying the applicant of the reconsidering step.

24. The method of claim 15 further comprising allowing the applicant to elect whether or not to participate in the reconsidering step.

25. The method of claim 15 wherein applications approved during the reconsideration period are granted a reduced line of credit.

26. The method of claim 15 wherein applications approved during the reconsideration period are granted for a trial period.

27. A system for processing credit card applications comprising:
a computer-readable memory that stores a new application received from an applicant; and
a computer communicatively connected to the computer-readable memory, the computer programmed to perform actions comprising the method of claim 15.

28. A system for considering credit card applications comprising:
an application processor for receiving a new application from an applicant and compiling credit information related to the applicant;
an application evaluator communicatively connected to the application processor for reviewing the credit information and making a decision to either decline or approve the application; and
a reconsideration database communicatively connected to the application evaluator and application processor for receiving a declined application from the application evaluator, storing the declined application, and providing the declined application to the application processor upon request.

29. The system of claim 28 wherein the application processor receives updated credit information for the declined application provided by the reconsideration database.

30. The system of claim 29 wherein the application evaluator reviews the updated credit information and makes a new decision to either decline or approve the application.

31. The system of claim 28 wherein the credit information comprises at least one FICO score.

32. The system of claim 28 wherein the application processor is communicatively connected to at least one credit bureau for requesting and obtaining the credit information.

33. The system of claim 28 wherein the reconsideration database is communicatively connected to a closed application database.

34. The system of claim 28 wherein the application evaluator is communicatively connected to a notification database.

35. The system of claim 28 wherein the application processor is communicatively connected to a new application database.

36. The system of claim 28 wherein the application processor is capable of accepting and processing an election made by the applicant to have his or her application stored in the reconsideration database.

37. A computer-implemented method of considering credit card applications, the method comprising:
receiving the application from an applicant;
storing information pertaining to the application in a computer-readable memory;
compiling credit information related to the applicant, wherein the compiling is performed by a computer;
storing the credit information in a computer-readable memory;
evaluating the application based at least upon the credit information to determine whether to approve or reject the application;
reconsidering the rejected application during a reconsideration period which is at least one month, wherein the reconsidering comprises receiving updated credit information and determining whether to approve or reject the application based at least upon the updated credit information; and
notifying the applicant of the reconsidering step.
